(19) United States
(12) Patent Application Publication
(10) Pub. No.: US 2004/0221232 A1
(43) Pub. Date: Nov. 4, 2004

(54) Method for readily storing and accessing information in electronic documents

(75) Inventor: Fabian F. Morgan, Austin, TX (US)

Correspondence Address: Darcell Walker, Suite 250, 9301 Southwest Freeway, Houston, TX, 77074, US

(73) Assignee: International Business Machines Corporation, Armonk, NY

(21) Appl. No.: 10/427,096

(22) Filed: Apr. 30, 2003

(51) Int. Cl. G06F 15/00

(52) U.S. Cl. 715/530

(57) ABSTRACT

The method of the present invention enables a user to highlight and store information from an article for later retrieval and review. A user highlights information in an article via pointing device such as a cursor controlled by a mouse. This highlighted information is painted a predetermined color such that the highlighted information is distinguished from the remainder of the article. The web browser keeps a folder of all the pages that are highlighted so that the user can easily find articles that the user has highlighted. Upon returning to the highlighted web page at a later time, the user is able to quickly find information along with the context of the information. A copy of the article as highlighted is stored in a file system at a predetermined or designated memory location.

### FIELD OF THE INVENTION

This invention refers to a method for storing and retrieving information in an electronic document and in particular to a method for easily highlighting a portion of an electronic document accessed via a computer network and storing the highlighted material such that the material can be accessed and easily identified at a later time.

### BACKGROUND OF THE INVENTION

It is well known to couple a plurality of computer systems into a network of computer systems. In this way, the collective resources available within the network may be shared among users, thus allowing each connected user to enjoy resources, which would not be economically feasible to provide to each user individually. With the growth of the Internet, sharing of computer resources has been brought to a much wider audience. The Internet has become a cultural medium in today's society for both information and entertainment. Government agencies employ Internet sites for a variety of informational purposes. For many companies, one or more Internet sites are an integral part of their business; these sites are frequently mentioned in the companies' television, radio and print advertising.

The World Wide Web, or simply “the Web”, is the Internet's multimedia information retrieval system. It is the most commonly used method of transferring data in the Internet environment. Other methods exist such as the File Transfer Protocol (FTP) and Gopher, but have not achieved the popularity the Web. Client machines accomplish transactions to Web servers using the Hypertext Transfer Protocol (HTTP), which is a known application protocol providing users access to files, e.g., text, graphics, images, sound, video, using a standard page description language known as the Hypertext Markup Language (HTML). HTML provides basic document formatting and allows the developer to specify “links” to other servers and files. In the Internet paradigm, a Uniform Resource Locator (URL) having a specific syntax for defining a network connection identifies a network path to a server.

Retrieval of information is generally achieved by the use of an HTML-compatible “browser”, e.g., Netscape Navigator, at a client machine. When the user of the browser specifies a link via a URL, the client issues a request to a naming service to map a hostname in the URL to a particular network IP address at which the server is located. The naming service returns a list of one or more IP addresses that can respond to the request. Using one of the IP addresses, the browser establishes a connection to a server. If the server is available, it returns a document or other object formatted according to HTML. Web browsers have become the primary interface for access to many network and server services.

The entry of the URL in the entry field of a browser can be a difficult task for many users. While the URL for the main Web page of a major company can be relatively brief, e.g., www.ibm.com, subsidiary pages can have very lengthy URLs in, at least to the average user, an arcane syntax. Recognizing the difficulties involved, the developers of browsers have provided one useful means of returning to a favorite URL, by the creation of user stored “bookmarks” in the browser.

Web browsers offer many options in the user interface for creating a bookmark list. Basic options let the user add and access a page through a pop-up menu on the location toolbar or through a menu pull down from the main menu bar. A simple way to add a bookmark for a favorite page is to enter the URL to travel to the page, once there, open the Bookmarks menu and choose the Add Bookmarks selection. This set of actions adds the URL of the current page as an item in the Bookmarks menu.

Once created, bookmarks offer a means of page retrieval. The user can cause the browser to display his bookmark list and select among his bookmarks to go directly to a favorite page. Thus, the user is not forced to enter a lengthy URL nor retrace the original tortuous route through the Internet by which he may have arrived at the Web site. Once a bookmark is added to a bookmark list, in general, the bookmark becomes a permanent part of the browser until removed. The permanence and accessibility of bookmarks have made them a valuable means for personalizing a user's Internet access through the browser.

One of the benefits of global computing networks is that the capability to equally and electronically access information provides an enhanced ability to perform research on a desired topic. Many resources such as encyclopedias have electronic versions that can be accessed via a global computing network. In addition, many companies and organization post activities on their web sites that a user can access, read and in some instances download to a local computer.

In a conventional research example, a person researching a topic may find an article related to the research topic. A person may read the article and highlight/identify certain portions of the article related to their topic. At a later time, the person may retrieve the article for review. The highlighted portions of the article make it easier to go through the article and retrieve the desired information from that article. Without the highlighted portions of the article, the researcher may need to re-read certain or substantial portions of the article.

The expansion of the Internet and other computing networks to include all types of electronic articles has changed some aspects of research. However other fundamental aspects of research remain the same. Whether researching numerous articles over the Internet for a presentation, or reading a 200-plus-page PDF document that serves as the installation/configuration guide for a particular product, users generally encounter pertinent information in electronic format that they want to readily access in the future. In the case of web browsers, the user can bookmark the page or pages that contain quotes or statistics he may want to use in a presentation, for example; however, upon returning to the bookmarked page, the user would need to sift through a number of paragraphs, figures, etc. in order to find the information that they had previously seen, or may even discover that this information has been removed due to an update to the web site. There is a similar problem with PDF documents, because although the user may recall that the important CLASSPATH setup information is in Chapter 9 (for example), the user still needs to sift through the paragraphs and pages in that chapter to find it. While such information may be emboldened or italicized, in scanning through multiple pages with emboldened text, the particular information the user wants may not be readily spotted.

Many of these documents accessed by users are in a Read-Only format. Therefore the user cannot employ common word processing techniques to mark these items such that the desired information can be readily view at a later time. There remains a need for a way to highlight the information in read-only type documents in a manner that is similar to highlighting the pages of a book, in order to quickly spot the information.

### SUMMARY OF THE INVENTION

It is an objective of the present invention to provide a method for storing contents of electronic read-only documents.

It is a second objective of the present invention to provide a method for highlighting contents of an electronic read-only document and storing those contents for retrieval at a later time.

It is a third objective of the present invention to provide a method to automatically store contents from an electronic document in another location for retrieval at another time.

The method of the present invention enables a user to highlight and store information from an article for later retrieval and review. The method of the invention is described in the context of an Internet web browser. However, this technique can be easily modified to apply to PDF documents, eBooks, tablet PC's, etc.

In the present invention, the user generally accesses a document via the Internet or some other global computing network. These types of documents are generally read-only documents, which means conventional highlighting techniques are not available to the user. However, the ability to temporarily mark portions of an article is available to the user. In the present invention, the user marks a sentence, phrase or section of an article with the mouse of the computer. Upon clicking the mouse button on the user's selection, along with the customary functions such as “Cut”, “Copy”, “Print” etc., which appear on the pop-up menu, a new entry called “Highlight” would also appear in the pop-up menu. The user would select this highlighter entry from the menu. This highlighter command causes the browser to highlight the identified portion of the article. This highlighted portion could be in a predefined color that is configurable (the highlight color will change depending on the background color of the web page). The highlighter command also saves a status copy of the page in the file system at a predetermined or designated location (in case highlighted information is removed via an update to the web page).

The browser keeps a folder of all the pages that are highlighted, similar to the “Favorites” or “Bookmarks” folder, so that the user can easily find the articles he/her has highlighted. Upon returning to a highlighted page several days later, the user is able to quickly find the information the user is looking for, along with the context for that information.

The process of the present invention can be installed as an application on a web browser or on a network server to give the user the ability to highlight portions of these types of electronic documents.

### DESCRIPTION OF THE DRAWING

FIG. 1 is a conventional computing device used for communication between users in a chat room environment via a computer network.

FIG. 2 is a diagram of a computer network over which messages may be transmitted between a user and the reservation center of the present invention.

FIG. 3 is a flow diagram of the conventional steps taken by a user to save information from a document accessed via a global computing network such as the Internet.

FIG. 4 is a flow diagram of the steps taken by a user to save information from a document accessed via a global computing network such as the Internet in accordance with the present invention.

FIG. 5 is a flow diagram of the steps in accordance with the method of the present invention.

FIG. 6 is an illustration of the screen display containing a highlighter icon that can be clicked to initiate the steps of the present invention.

FIG. 7 is an illustration of document with a highlighted portion that a user desires to retain.

### DETAILED DESCRIPTION OF THE INVENTION

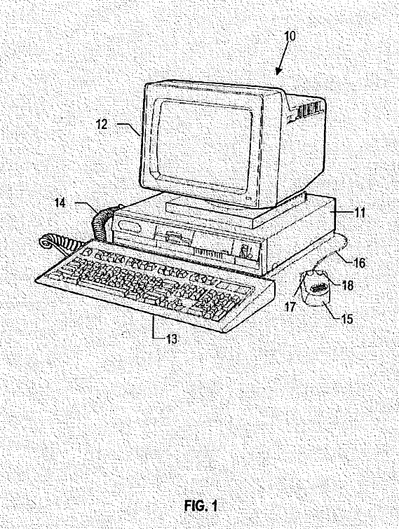

With reference now to FIG. 1, there is depicted a pictorial representation of computing device 10 which may be used in implementation of the present invention. As may be seen, data processing system 10 includes processor 11 that preferably includes a graphics processor, memory device and central processor (not shown). Coupled to processor 11 is video display 12 which may be implemented utilizing either a color or monochromatic monitor, in a manner well known in the art. Also coupled to processor 11 is keyboard 13. Keyboard 13 preferably comprises a standard computer keyboard, which is coupled to the processor by means of cable 14. Also coupled to processor 11 is a graphical pointing device, such as mouse 15. Mouse 15 is coupled to processor 11, in a manner well known in the art, via cable 16. As is shown, mouse 15 may include left button 17, and right button 18, each of which may be depressed, or “clicked”, to provide command and control signals to data processing system 10. While the disclosed embodiment of the present invention utilizes a mouse, those skilled in the art will appreciate that any graphical pointing device such as a light pen or touch sensitive screen may be utilized to implement the method and apparatus of the present invention. Upon reference to the foregoing, those skilled in the art will appreciate that data processing system 10 may be implemented utilizing a personal computer.

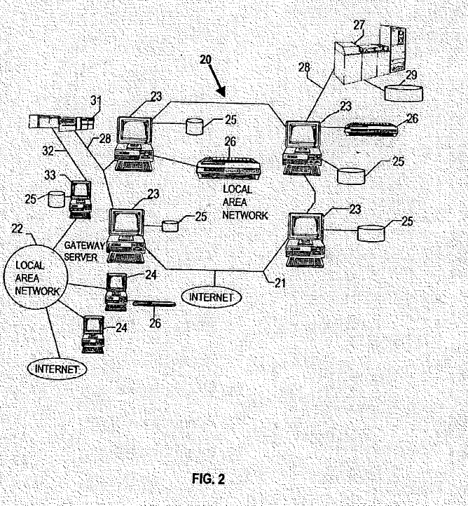

The method of the present invention may be implemented in a global computer network environment such as the Internet. With reference now FIG. 2, there is depicted a pictorial representation of a distributed computer network environment 20 in which one may implement the method and system of the present invention. As may be seen, distributed data processing system 20 may include a plurality of networks, such as Local Area Networks (LAN) 21 and 22, each of which preferably includes a plurality of individual computers 23 and 24, respectively. Of course, those skilled in the art will appreciate that a plurality of Intelligent Work Stations (IWS) coupled to a host processor may be utilized for each such network. Any of the processing systems may also be connected to the Internet as shown. As is common in such data processing systems, each individual computer may be coupled to a storage device 25 and/or a printer/output device 26. One or more such storage devices 25 may be utilized, in accordance with the method of the present invention, to store the various data objects or documents which may be periodically accessed and processed by a user within distributed data processing system 20, in accordance with the method and system of the present invention. In a manner well known in the prior art, each such data processing procedure or document may be stored within a storage device 25 which is associated with a Resource Manager or Library Service, which is responsible for maintaining and updating all resource objects associated therewith.

Still referring to FIG. 2, it may be seen that distributed data processing system 20 may also include multiple mainframe computers, such as mainframe computer 27, which may be preferably coupled to Local Area Network (LAN) 21 by means of communications link 28. Mainframe computer 27 may also be coupled to a storage device 29 which may serve as remote storage for Local Area Network (LAN) 21. A second Local Area Network (LAN) 22 may be coupled to Local Area Network (LAN) 21 via communications controller 31 and communications link 32 to a gateway server 33. Gateway server 33 is preferably an individual computer or Intelligent Work Station (IWS), which serves to link Local Area Network (LAN) 22 to Local Area Network (LAN) 21. As discussed above with respect to Local Area Network (LAN) 22 and Local Area Network (LAN) 21, a plurality of data processing procedures or documents may be stored within storage device 29 and controlled by mainframe computer 27, as Resource Manager or Library Service for the data processing procedures and documents thus stored. Of course, those skilled in the art will appreciate that mainframe computer 27 may be located a great geographical distance from Local Area Network (LAN) 21 and similarly Local Area Network (LAN) 21 may be located a substantial distance from Local Area Network (LAN) 24. That is, Local Area Network (LAN) 24 may be located in California while Local Area Network (LAN) 21 may be located within Texas and mainframe computer 27 may be located in New York.

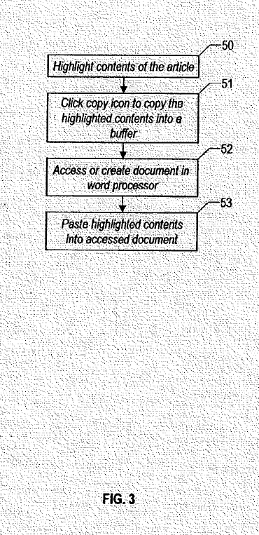

FIG. 3 illustrates the steps in the conventional method for saving and retrieving information found on an article accessed via a global computing network. When a user desires to retain information, the user will highlight a portion of the article in step 50. The user then clicks the copy icon in step 51 to copy that portion of the article into a buffer. This step is the same as if the user were in a word processor performing cut and paste operations. In step 52, the user then accesses or creates a document in a word processor and pastes the contents in the accessed or created document in step 53.

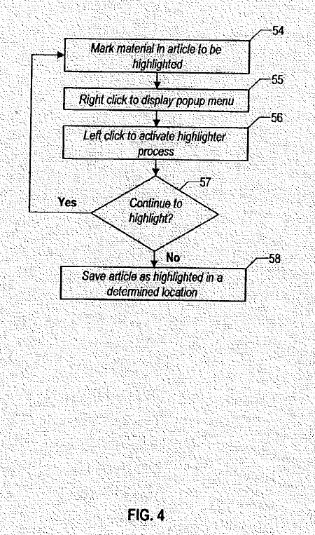

The present invention provides a method to identify materials in articles for later retrieval and review. The method will be described in the contents of an article accessed by a user via the Internet. Referring to FIG. 4, the user will use the left button of the mouse to mark a desired portion of an article accessed from a web site in step 54. The user can then click the right button of the mouse to cause a popup menu display to appear on the screen. This menu contains the highlighter icon in step 55. The user can then use left mouse button to click the highlighter icon to initiate or activate the performance of the highlighter function as shown in step 56. As part of step 56, the highlighter function will color the identified portion of the article such that it distinguished from the other portions of the article. Because an article can have several portions that the user may want to highlight, in step 57, the user can decide whether to continue highlighting other portions of the article or save the article as highlighted. If the user has finished highlighting an article, the highlighted article can be saved as highlighted to a predetermined or default location in step 58. The storage location can be on the local user machine, or on a network location such as network server.

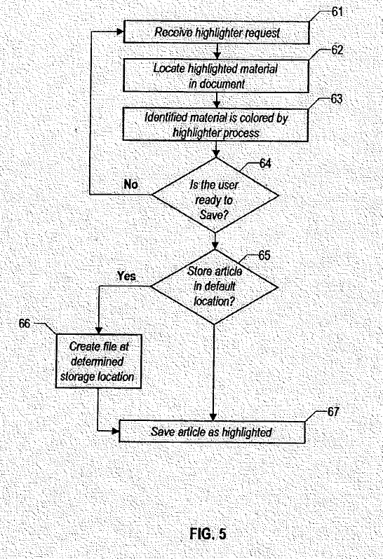

FIG. 5 describes the process of the present invention from the process application implemented in a system location such as a web browser. Referring to FIG. 5 in step 61, a request to highlight is received by the highlighter process of the present invention. In step 62, the highlighted material is identified from the highlighted material identified by the user. The highlighting process then colors the highlighted material in step 63. The colored material can have a different colored background that is different from the background of the article. The article can also have a different color for the characters in the article. A determination of the appropriate color for the highlighted material will be determined internally in step 63. In step 64, there is a determination as to whether the user wants to save the article as currently highlighted or continue to find and highlight other portions of the article. If the user does want to highlight other portions of the article, the process will return to step 62. If the user has completed the highlighting exercise, in step 65 it is necessary to determine where to save the article. As previously mentioned, there can be various places to store the highlighted article. One storage option is a default storage location, wherein the article is automatically in a location such as a previously identified server location. If there is no default option, the process will create file for that article in step 66. In step 67, the highlighted article is stored for future retrieval and review. In step 68, the page containing highlighted material is stored in the file system at a predetermined or designated location. Storage of the highlighted materials as described will enable a user to immediately access the information.

The browser also keeps a folder of all the pages that are highlighted, similar to the “Favorites” or “Bookmarks” folder, so that the user can easily find the articles he/her has highlighted. Upon returning to a highlighted page several days later, the user is able to quickly find the information the user is looking for, along with the context for that information.

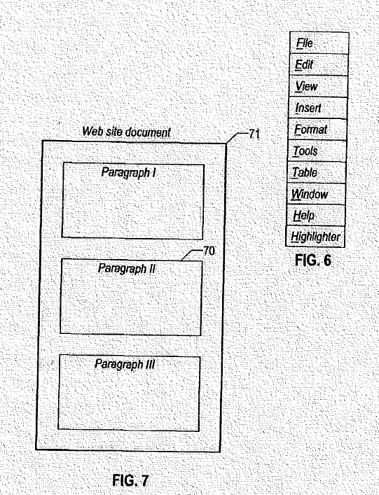

FIG. 6 shows a popup menu that can contain a highlighter icon that the user can click with the right button to initialize the highlighter process.

FIG. 7 shows a document from an article on a web site. This article as has three paragraphs on this page. If the user desires to highlight the second paragraph 70 of the article 71, the user would click the left button on the mouse to highlight the contents of paragraph 70. The user would then click the right button on the mouse to cause the highlighter icon to appear from the popup menu. The user could then click the left button on the mouse to activate the highlighter icon and start the highlighter process.

In accordance with the method of the present invention, the second paragraph 70 will be highlighted on that page of the article. This page 71 will be stored in a file system at a predetermined or designated location. This storage will secure the highlighted materials in the event something happens to the web page containing the accessed article such as the page being changed or the article being deleted from the web page. The browser creates a folder of this highlighted article so that the user can quickly identify desired materials.

An alternate method of the present invention automatically creates a new document containing the article or a portion of the article with the desired materials highlighted. In this embodiment, the user highlights the desired materials from the article. Once the user clicks the highlight icon, a request is sent to the highlighter process. The process then locates the highlighted materials in the article. The highlighted materials are colored such that this material is distinguished from the remainder of the article. At this point, the entire article can be saved in a storage location. In the alternative, the user can decide to store only the highlighted portion of the article.

Although the present invention was described in the context of an article accessed via the Internet, a version of the method of the present invention can be implemented for a reference within a PDF document obtained from an Internet location. In this method, a user highlights information via a pointing device within the PDF document, which causes a browser to paint the information in a predefined color. A static copy of the page containing the highlighted information is saved in a file system at a predetermined or designated location, along with an indicator. Subsequent accesses of the information via the indicator cause a copy of the page to be displayed with the highlighted information.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

I claim:

1. A method for identifying portions of a document for retrieval at a later time comprising the steps of:
identifying a certain portion of a document;
marking the identified portion of the document within the document;
establishing an identifier that will allow for direct access to the document as marked herein; and
retrieving the document as marked via the established identifier.

2. The method as described in claim 1 wherein said marking step further comprises:
determining a color that will distinguish the identified portion of the document from the remainder of the document; and
transforming the identified portion of the document to the determined color such that the identified portion is of the document is distinguished from the other portions of the document.

3. The method as described in claim 2 wherein said color-transforming step comprises coloring the characters of the identified portion of the document.

4. The method as described in claim 2 wherein said color-transforming step further comprises coloring the characters and the background of the identified portion of the document.

5. The method as described in claim 1 further comprising before said document retrieving step, the step of storing the established identifier of the document in a folder.

6. The method as described in claim 5 wherein said established identifier is stored in a web browser folder.

7. The method as described in claim 1 further comprising the step of saving the highlighted document in a file system at a designated location.

8. The method as described in claim 1 further comprising the step of saving the highlighted portions of a document in a file system at a designated location.

9. A computer program product in a computer readable medium for identifying portions of a document for retrieval at a later time comprising:
instructions for identifying a certain portion of an document;
instructions for marking the identified portion of the document within the document;
instructions for establishing an identifier that will allow for direct access to the document as marked herein; and
instructions for retrieving the document as marked via the established identifier.

10. The computer product program as described in claim 9 wherein said marking instructions further comprise:
instructions for determining a color that will distinguish the identified portion of the document from the remainder of the document; and
instructions for transforming the identified portion of the document to the determined color such that the identified portion is of the document is distinguished from the other portions of the document.

11. The computer product program as described in claim 10 wherein said color-transforming instructions further comprise instructions for coloring the characters of the identified portion of the document.

12. The computer product program as described in claim 10 wherein said color-transforming instructions further comprise instructions for coloring the characters and the background of the identified portion of the document.

13. The computer product program as described in claim 9 further comprising before said document retrieving instructions, instructions for storing the established identifier of the document in a folder.

14. The computer product program as described in claim 13 further comprising instructions for storing established identifier in a web browser folder.

15. The computer product program as described in claim 9 further comprising instructions for saving the highlighted document in a file system at a designated location.

16. The computer program product as described in claim 9 further comprising instructions for saving the highlighted portions of a document in a file system at a designated location.

17. The method of claim 1 wherein the document is a read-only document.

18. A method for identifying portions of an electronic read-only document for retrieval at a later time comprising the steps of:
identifying a certain portion of an document;
marking the identified portion of the document within the document;
establishing an identifier that will allow for direct access to the document as marked herein; and
retrieving the document as marked via the established identifier.

19. The method as described in claim 18 wherein said marking step further comprises:
determining a color that will distinguish the identified portion of the document from the remainder of the document; and
transforming the identified portion of the document to the determined color such that the identified portion is of the document is distinguished from the other portions of the document.

20. The method as described in claim 19 wherein said color-transforming step comprises coloring the characters of the identified portion of the document.

21. The method as described in claim 18 further comprising before said document retrieving step, the step of storing the established identifier of the document in a folder.

22. The method as described in claim 18 further comprising the step of saving the highlighted document in a file system at a designated location.

23. The method as described in claim 18 further comprising the step of saving the highlighted portions of a document in a file system at designated location.
